(19) United States
(12) Patent Application Publication
(10) Pub. No.: US 2009/0300122 A1
(43) Pub. Date: Dec. 3, 2009

(54) AUGMENTED REALITY COLLABORATIVE MESSAGING SYSTEM

(76) Inventor: Carl Johan Freer, Westport, CT (US)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 12/175,519

(22) Filed: Jul. 18, 2008

Related U.S. Application Data
(60) Provisional application No. 61/057,471, filed on May 30, 2008.

(51) Int. Cl. G06F 15/16

(52) U.S. Cl. 709/206

(57) ABSTRACT

An augmented reality messaging platform is provided which interacts between one or more mobile device and a server via a communication network. The augmented reality platform includes an image recognition application located on the mobile device which receives a live, real-time image and identifies objects, such as markers or logos, within the environment to determine the pose (position and orientation) of the camera. The data, in combination with user information, is used to send, retrieve and display digital, spatialized (those registered with the physical world) multimedia messages, including audio, video, text and virtual object. A server application provided on the server may receive and store the messages from the client application or may deliver appropriate messages to a receiving mobile device, based on a set of privacy rules. The client application on the mobile device processes and renders this content thereto and forms an augmented reality image on a display of the mobile device based on the live, real-time image and the content. The client application is further capable of uploading new message content to be stored on a centralized server through methods which are specific to the medium of the message.

### CROSS-REFERENCE TO RELATED APPLICATION

This application claims priority under 35 U.S.C. §119(e) of U.S. provisional patent application Ser. No. 61/057,471 filed May 30, 2008, which is incorporated by reference herein.

### FIELD OF THE INVENTION

The present invention relates generally to a method and system for implementing an augmented reality system for collaborative messaging.

The present invention also relates to an augmented reality software platform designed to deliver dynamic and customized augmented reality messages to mobile devices.

The present invention also relates to a distributed, augmented reality software platform designed to transport and support augmented reality messages to mobile devices.

### BACKGROUND OF THE INVENTION

Augmented reality is an environment that includes both virtual reality and real-world elements, is interactive in real-time, and may be three-dimensional.

There are numerous known applications of augmented reality. However, none of the conventional applications allow users to send and receive virtual messages to one another that are spatially registered in 3-dimensions with real-world objects. That is, none of the current applications allow participants to dynamically create and receive computer-mediated communications that are bound to items in the physical world. Further, none of these applications allow for these messages to be exposed according to a set of privacy rules that allow for public messaging to private notes between individuals.

The benefits of such a system are derived from the mobile form factor. Mobile devices are personal—often containing information that is considered confidential—and are almost always located directly on or near to the owner. Given their relatively small screen size and portability, mobile devices can also display messages in ways that are not possible on larger display surfaces. For example, it is indeed possible when receiving a message on a mobile device, to view the message in an appropriate setting by taking the device into a more-private environment—purely based on the sensitivity of the data and the context of the environment. The size of the screen also prohibits the screen from being understood from long distances, creating a small zone in which the message will generally be considered as viewable.

Today, many people carry mobile devices, such as personal digital assistant (PDA) devices and cellular telephones (e.g., cellular camera phones). Such electronic devices typically include a camera or other imaging component capable of obtaining images to be displayed on a display component. They further contain enough computing power and devices that it is possible to run location-aware applications.

However, current mobile devices are not capable of providing messaging and media delivered spatially—that is, where virtual content is registered to objects in the physical world. By combining virtual content with physical objects, it is possible for users to send and receive digital content asynchronously to others using physical spaces as a centralized point of communication.

### SUMMARY OF THE INVENTION

The present invention provides a new and improved method and system for enabling a mobile device to apply augmented reality messaging techniques.

According to one aspect of the present invention, a distributed augmented reality software platform is provided which is capable of delivering dynamic and/or customized augmented reality messages to mobile devices.

According to another aspect of the present invention, a method and system for implementing augmented reality is provided wherein the virtual content is displayed through the recognition of an identifiable real-world element, such as a marker or logo.

More specifically, an augmented reality platform in accordance with the invention generally includes software and hardware components capable of live image capture (at the mobile device), establishing connections between the mobile device and other servers and network components via one or more communications networks, transmitting communications or signals between the mobile device and the server and network components, retrieving data such as messages from databases resident on the mobile device or at the server or from other databases remote from the mobile device, cataloging data about content (e.g. logging) to be provided to the mobile device for the augmented reality experience and rendering the message using the mobile device. With such structure, the invention provides a complete mobile delivery platform and can be created to function on all active mobile device formats (regardless of operating system).

Further, the platform contains the ability to compose, send, and retrieve computer-mediated communications in a variety of formats, including text, audio, video and virtual content such as 3D models.

A platform in accordance with the invention is modeled using a distributed computing/data storage model, i.e., the computing and data storage is performed both at the mobile device and at other remote components connected via a communications network with the mobile device. As such, the platform in accordance with the invention differs from current augmented reality platforms which are typically self-contained within the mobile device, i.e., the mobile device itself includes hardware and software components which obtain images and then perform real-time pattern matching (whether of markers or other indicia contained in the images) to ascertain content to be displayed in combination with live images, and retrieve the content from a memory of the mobile device. These current platforms typically comprise a single application transmitted to and stored on the mobile device without any involvement of a remote hardware and/or software component during the pattern matching and content retrieval stages.

In a specific implementation, an augmented reality platform in accordance with the invention provides for real-time live pattern recognition of markers using mobile devices involving one or more remote network components. When a logo or marker in an obtained image has been recognized, or identified, the mobile device becomes aware that it is located in an area in which messaging can occur. Virtual messages that are intended for the recipient can be retrieved and rendered while in this physical shared space, and new virtual messages may be created and posted for others.

An important advantage of the invention is in how the user interacts with the system. Here, we described one implementation. Physical bulletin boards are ubiquitous and can be located in almost any physical structure—from pubs to schools; they serve as an effective central point of communication and allow for a wide variety of printed material to be posted; however, the content of the board is the same for each person who views it. Some items may not be of interest to a user. It is also common for a user from the general public to have mobile device that is always available to them. Through combining these two aspects, the physical bulletin board can serve as a public method of content delivery, including customized commercial ads, requests for service, and personal ads, or notes for friends. The content that is posted to such space can include audio, video, text and newer forms of multimedia including, but not limited to, virtual objects.

Another advantage of this approach is in the level of privacy that is available through such a system. Traditional public display surfaces expose information for any willing participant to view, and provide no restrictions in what is seen. While this certainly may be the intent of the message, it is indeed possible to restrict access to those who meet certain criteria, such as family, friends or members of a community.

Yet another advantage is in how the messages may be replicated. Because the information is not physical, it can be digitally sent across a networking infrastructure and be posted to the larger community (e.g. a set of display surfaces), including other bulletin boards, television, mobile devices or other forms of display.

In an ideal embodiment, the user has the ability to create video, audio, text or other asynchronous message (such as the creation of virtual objects) and post them to a physically shared surface. During this time, a user can list the intended recipients of the message, which may consist of the general public, a community group, a set of friends, family members or individuals. At a later date, the content may be retrieved by the intended recipient(s) and viewed in a variety of ways, but ideally while viewing the physical surface through the display of the phone. Thus, the display of the mobile device acts as a window into the virtual world, allowing the user to see the virtual content superimposed above the physical surface.

In addition to traditional forms of media, this embodiment allows for interesting variations of messaging techniques, including leaving personalized virtual paintings on the bulletin board—something not possible with other messaging systems. In another embodiment, the user records video and “posts” it as a message for one or more recipients; for example, they may post video of themselves during a trip for other family members to later see, or a group of friends may video themselves in a pub or restaurant (the success of which can be seen in restaurants who post images of their customers). In another embodiment, they post a simple text message to the public telling them about their experience in that location.

In another embodiment, the shared space can be physically replicated such that a post on one messaging space can be retrieved in a different physical space. Thus, a posting on one board can be seen on a different board—allowing for messages to be propagated to the larger community.

### BRIEF DESCRIPTION OF THE DRAWINGS

The invention, together with further advantages thereof, may best be understood by reference to the following description taken in conjunction with the accompanying drawings, wherein like reference numerals identify like elements, and wherein:

FIG. 1 is a schematic showing the primary components of an augmented reality platform in accordance with the invention.

FIG. 2 is a schematic showing the registration process that occurs in accordance with the invention.

FIG. 3 is a schematic that shows the relationship between various users and the centralized server or set of servers.

### DETAILED DESCRIPTION OF THE INVENTION

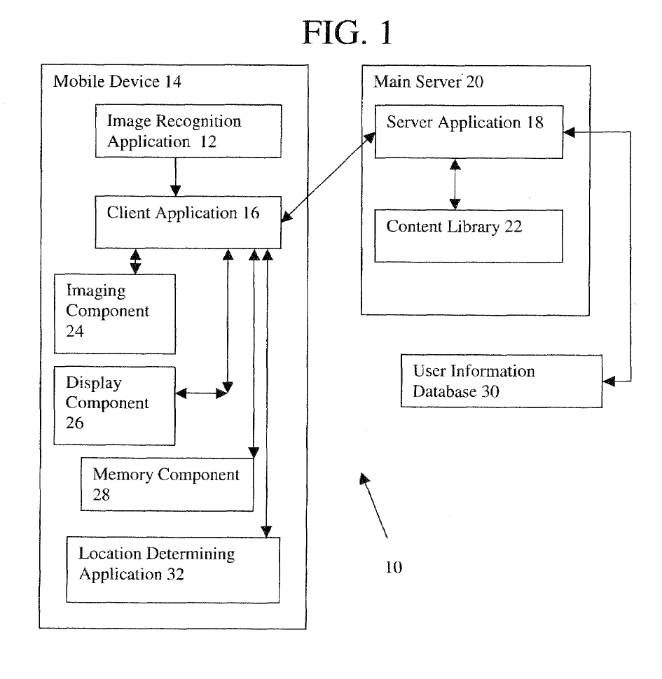

Referring to the accompanying drawings wherein like reference numerals refer to the same or similar elements, FIG. 1 shows primary components of the augmented reality platform which interacts with identifiable objects (such as markers or logos) in accordance with the invention, designated generally as 10. The primary components of the platform 10 include an image recognition application 12 located on the user's mobile device 14, a client application 16 located and running on the user's mobile device 14, a server application 18 located and running on a (main) server 20, and a content library 22 which contains the content or messages thereto being provided to the mobile device 14. All of the primary components of the platform 10 interact with one another, e.g., via a communications network, such as the Internet, when the interacting components are not co-located, i.e., one component is situated on the mobile device 14 and another is at a site remote from the mobile device 14 such as at the main server 20.

The image recognition application 12 is coupled to the imaging component 24 of the mobile device 14, i.e., its camera, and generally comprises software embodied on computer-readable media which analyzes images being imaged by the imaging component 24 (which may be an image of only a logo or an image containing a logo) and interprets this image into coordinates which are sent to the client application 16. The images are not necessarily stored by the mobile device 14, but rather, the images are displayed live, in real-time on the display component 26 of the mobile device 14.

To aid in the interpretation of the images into coordinates, a marker may be formed in combination with the logo and is related to, indicative of or provides information about the environment. As such, the coordinates may be generated by analyzing the marker. The marker may be a frame marker forming a frame around the logo.

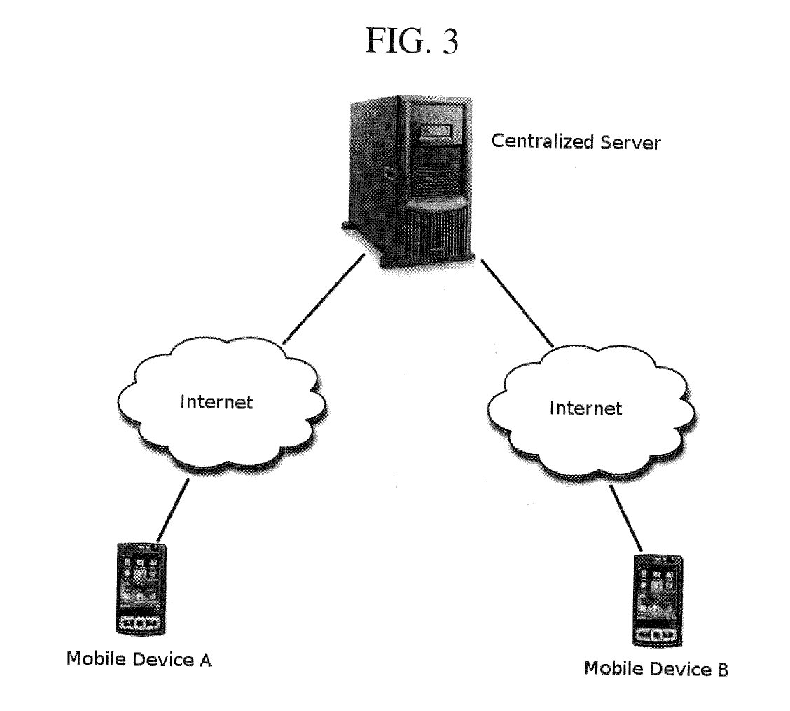

The relationship between individual user and the centralized server is described in FIG. 3. Messages can be created either through the mobile device A or other equivalent computing device. Messages may be comprised of audio, video, text or other content such as virtual objects. Upon approaching a shared physical space, it space is identified through image identification (using a marker or logo) by device A, and the user of said device is presented with a menu of options for uploading or retrieving messages. These messages are transmitted via a wireless connection to a centralized server as shown in FIG. 3. The said message is stored on said server (or set of servers) to later be retrieved by a second user in possession of device B, which is capable of rendering the content.

The client application 16 may be considered the central hub of software on the mobile device 14. It receives the coordinates from the image recognition application 12 and transmits information (e.g. via XML) to the server application 18 which may include user information for identification, as well as location information. After the server application 18 locates the appropriate set of messages, based on the aforementioned identification, it sends the content to the mobile device 14, the client application 16 processes that content and forms a display on the display component 26 of the mobile device 14 based on the live image and the content.

The server application 18 may be located on a set of servers interconnected by the Internet. The client application 16 contacts the server application 18 and passes a query string, containing the coordinates derived from the live, real-time image being imaged by the mobile device 14. The server application 18 parses that string, queries for the appropriate content/message library 22, retrieves the proper content/message thereto from the content library 22 and then encrypts the content or message thereto and directs it to the client application 16.

Additionally, the server application 18 may be designed to log the activity, track and create activity reports and maintain communication with all active client applications 16. That is, the server application 18 can handle query strings from multiple client applications 16.

The content library 22 may be located on a separate set of servers than the server application 18, or possibly on the same server or set of servers. The illustrated embodiment shows the main server 20 including both the server application 18 and the content library 22 but this arrangement is not limiting and indeed, it is envisioned that the content library 22 may be distributed over several servers or other network components different than the main server 20.

The content library 22 stores all augmented reality content thereto that are to be delivered to client applications 16. The content library 22 receives signals from the server application 18 in the form of a request for content responsive to coordinates derived by the image recognition application 12 from analysis of a live, real-time image in combination with user-identification data. When it receives the request, the content library 22 first authenticates the request as a valid request, identifies the user involved, verifies that the server application 18 requesting the information is entitled to receive a response, then retrieves the appropriate stored message thereto and delivers that content to the server application 18.

To use the platform 10, the user's mobile device 14 would be provided with the client application 16 which may be pre-installed on the mobile device 14, i.e., prior to delivery to the user, or the user could download the client application 16 via an SMS message, or comparable protocol for delivery, sent from the server application 16.

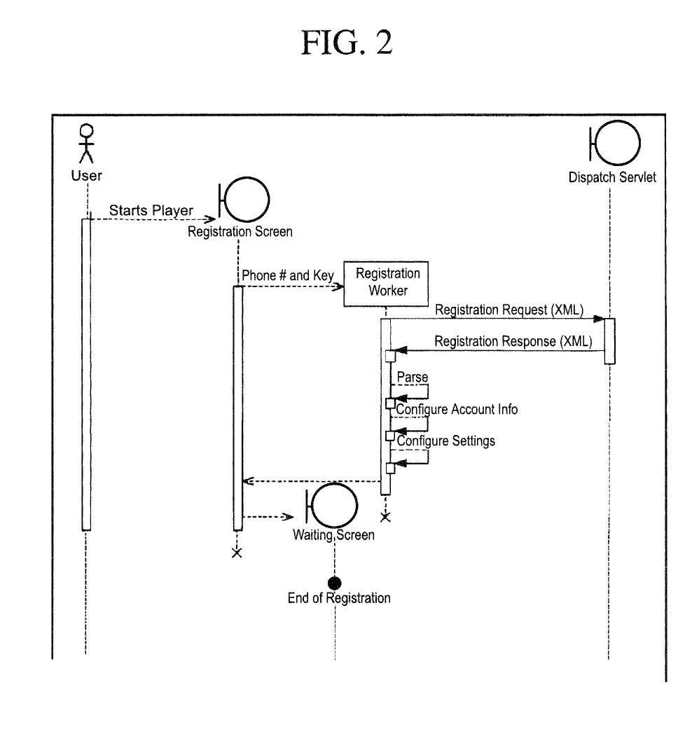

Registration to use the augmented reality platform 10 is preferably required and FIG. 2 shows a registration process diagram which would be the first interaction between the user and the client application 16, once installation on the mobile device 14 is complete. The user starts the client application 16 and is presented with a registration screen. The user enters their phone number of the mobile device 14 and a key or password indicating their authorization to use the mobile device 14. A registration worker generates and sends a registration request to a dispatch servlet via a communications network which returns a registration response. The registration worker parses the response, configures account information and settings and then indicates when the registration is complete. During the registration process, the user may be presented with a waiting screen.

After registration, the user is able to run the client application 16 as a resident application on the mobile device 14. This entails selecting the application, then entering the “run” mode and pointing the imaging component 24 of the mobile device 14 towards an identifiable object. The image recognition application 12 analyzes the live image, which may be entirely the logo or marker, and converts it into a series of coordinates. The client application 16 receives the coordinates from the image recognition algorithm 12 and encrypts the coordinates along with user identification data and prepares them for transmission to the server 20 running the server application 18, preferably in the form of a data packet or series of packets. After the client application 16 has transmitted the data packet, the client application 16 waits for a response from the server application 18.

The client application 16 also retrieves the content/message and displays the content within the display component 26 of the mobile device 14 by merging the content with the live, real-time image being displayed on the display component 26. The content, if an image, may be superimposed on the live image, and can be spatially registered to the physical world.

To ensure that the client application 16 is the latest version thereof, the client application 16 may be arranged to connect to the server 20 running the server application 18 based on a pre-determined timeframe and perform an update process. This process may be any known application update process and generally comprises a query from the client application 16 to the server 20 to ascertain whether the client application 16 is the latest version thereof and if not, a transmission from the server 20 to the mobile device 14 of the updates or upgrades.

The server application 18 may receive input from the client application 16 via XML interface.

The server application 18 performs a number of basic interactions with the client application 16, including a registration process (see FIG. 2), a registration response process, an update check process and an update response. With respect to the update processes, as noted above, the client application 16 is configured to respond to the server application 18 based on a pre-determined time frame which may be on an incremental basis. This increment is set within the client application 16.

The primary function of the server application 18 is to provide a response to the client application 16 in the form of content or a message thereto. The response is based on the coordinates in the data packet transmitted from the mobile devices 14. Specifically, the server application 18 may be arranged to decrypt the information string sent from the client application 16 using the key provided with the data, parse the response into appropriate data delimited datasets, and query one or more local or remote databases to authenticate whether the mobile device 14 has been properly registered (i.e., includes a source phone number, key returned). If the server application 18 determines that the mobile device 14 has been properly registered, then it proceeds to interpret the data coordinates and determines if they possess a valid pattern (of a logo). If so, the coordinates are placed into an appropriate data string and a query is generated and transmitted to the content library 22 for a match of coordinates. If an appropriate data coordinate match is found by the content library 22 (indicating that content library 22 can associate appropriate content or a message thereto with the logo from which the data coordinates have been derived), the server application 18 receives the appropriate content or a message to the appropriate content (usually the latter).

The appropriate content, voucher information, a new encryption key and the current key are encrypted into a new data packet and returned by the server application 18 to the client application 16 of the mobile device 14 as an XML string. The server application 18 then logs the action undertaken in a database, i.e., it updates a device record with the new key, and the date and time of last contact, it updates an advertiser record with a new hit count (the advertiser being the entity whose goods and/or services are associated with the logo or a related or contractual party thereto), it updates the content record with transaction information and it also updates a server log with the transaction. The server he—application 18 then returns to a ready or waiting state for next connection attempt from a mobile device 14, i.e., it waits for receipt of another data packet from a registered mobile device 14 which might contain data coordinates derived from an image containing a logo.

The content library 22 is the main repository for all content and messages disseminated by the augmented reality platform 10. The content library 22 has two main functions, namely to receive information from the server application 18 and return the appropriate content or message thereto, and to receive new content from a content development tool. The content library 22 contains the main content library record format (Content UID, dates and times at which the content may be provided, an identification of the advertisers providing the content, message content, parameters for providing the content relative to information about the users, such as age and gender). The content library 22 also contains a content log for each content record which includes revision history (ContentUID, dates and times of the revisions, an identification of the advertisers, an identification of the operators, actions undertaken and software keys).

By associating information about the users with content and messages in the content library 22, information about the user of each mobile device 14 is thus considered when determining appropriate messages to provide to the mobile device 14. This information may be stored in the mobile device 14 and/or in a database (user information database 30) associated with or accessible by the main server 20 and is retrieved by the main server when it is requesting content from the content library 22. The main server 20 would therefore provide information about the user to the content library 22 and receive one of a plurality of different content or messages to content depending on the user information and the privacy roles they play.

Alternatively, the content library could provide a plurality of content and messages thereto based solely on the logo or marker and the main server 20 applies the user information to determine which content or message thereto should be provided to the mobile device 14.

Instead of or in addition to considering information about the user when determining appropriate content to provide to the user's mobile device 14, it is possible to consider the location of the mobile device 14. A significant number of mobile devices include a location determining application for determining the location thereof, whether using a GPS-based system or another comparable system. In this case, the client application 16 may be coupled to such a location determining application 32 and provide information about the location of the mobile device 14 in the data packet being transmitted to the server application 18 to enable the server application 18 to determine appropriate content to provide based on the coordinates and the information about the location of the mobile device 14, which may also be customized to the capabilities of the phone.

The foregoing structure enables methods for a user's mobile device 14 to interact with physical structures to send and receive message virtual messages. The user can therefore view a a physical structure such as a billboard, and post or receive virtual pre-made messages of a variety of formats. For example, a user may wish to post a video ad for the general public to see. Upon uploading the video, a different user can walk up to the bulletin board and view the video. In another example, a user may wish to leave their picture on the bulletin board that only their friend may access.

To customize the content of the message on mobile device 14, the user may be presented with a variety of interfaces that are specific to the medium of the message. The information may be stored in the mobile device 14 and/or in a database accessible to or associated with the main server 20.

In view of the foregoing, the invention also contemplates a mobile device 14 capable of implementing augmented reality techniques which would include an imaging component 24 for obtaining images, a display component 26 for displaying live, real-time images being obtained by the imaging component 24, an image recognition application 12 as described above and a client application 16 coupled to the image recognition application 12 and the display component 26. The functions and capabilities of the client application 16 are described above. The mobile device 14 could also include a memory component 28 including information about a user of the mobile device which could be entered therein by a user interface of the mobile device 14. The client application 16 could then transmit information about the user from the memory component 28 to the remote server 20 with the coordinates derived from the live images being obtained by the imaging component 24. The mobile device 14 optionally includes a location determining application 32 for determining the location of the mobile device 14. In this embodiment, the client application 16 may transmit information about the location of the mobile device 14 to the server 20 with the coordinates.

It is to be understood that the present invention is not limited to the embodiments described above, but include any and all embodiments with in the scope of the following claims.

While the invention has been described above with respect to specific apparatus and specific implementations, it should be clear that various modifications and alterations can be made, and various features of one embodiment can be included in other embodiments, within the scope of the present invention.

1. A distributed augmented reality platform which interacts between several mobile devices and a server, comprising:
an image recognition application located on the mobile device which receives a live, real-time image imaged by an imaging component of the mobile device, and which identifies the orientation and location of the device;
a client application located on the mobile device which receives the above said data from the image recognition application, and is capable of generating, sending, receiving and rendering multimedia messages in a variety of formats, including video, audio, text and virtual 3D content;
a server application located on the server which receives the transmission of the a client message, saves these messages for later retrieval, determines any content that may need to be provided to the mobile device based on the coordinates, and sends the content or message thereto to a mobile device.

2. An augmented reality platform of claim 1, in which the client device is capable of rendering messages provided by clients of another device. These messages may be in the form of traditional multimedia (e.g. audio/video/text).

3. The distributed augmented reality platform of claim 1, wherein the augmented reality messages may be comprised of new forms of media, including virtual objects.

4. The distributed augmented reality platform of claim 1, further comprising a memory which stores information about the messages that have been sent those that must be delivered. The distribution of these messages occurs between a centralized set of servers and one or more mobile devices.

5. A method of providing an augmented reality experience on a mobile device, comprising:
creating messages in the form of multimedia elements, including video, audio, text and/or virtual objects.
obtaining a live, real-time image using an imaging component of the mobile device;
determining the location and orientation of the mobile device;
providing the ability for users to create, send and receive multimedia messages of a wide variety of formats.
rendering of a wide variety of media formats, including the superimposition of virtual content within the physical environment

6. The method of claim 5, wherein the mobile device derives coordinates of the live, real-time image and transmits the derived coordinates to a server in a data packet, and wherein the server delivers messages appropriate to the user.

7. The method of claim 6, wherein the server is coupled to a content library which stores messages of varying levels of privacy, and appropriately delivers them according to claim

8. The method of claim 5, wherein the mobile device is capable of displaying an augmented reality image comprising the content superimposed on the live, real-time image.

9. The method of claim 5, wherein the logo contained in the live, real-time image is identified by identifying a marker, potentially formed in combination with a logo.

10. The method of claim 9, wherein the marker comprises a frame—potentially formed around a logo.

11. The method of claim 5, wherein the content comprises a personal or commercial message intended for one or more persons.

12. A mobile device comprising:
an imaging component which obtains a live, real-time image, and converts the image into coordinates;
a transmitting unit which transmits a data packet including the coordinates and message to be delivered;
a receiving unit which receives appropriate messages containing a variety of multimedia content that may include audio, video, text and/or virtual objects; and
a display which capable of displaying this content in a spatialized way—that is, the virtual content is registered with the physical world.

13. The mobile device of claim 12, wherein the image displayed by the display comprises an augmented reality image in which the content is superimposed on the live, real-time image obtained by the imaging component.

14. The mobile device of claim 12, further comprising a memory storing information about a user of the mobile device, wherein the content thereto received by the receiving unit is determined based on the information about the user as well as the coordinates included in the data packet.

15. The mobile device of claim 12, wherein the coordinates of the data packet include the coordinates of a marker and/or logo.
